(19) United States
(12) Patent Application Publication
(10) Pub. No.: US 2021/0304294 A1
(43) Pub. Date: Sep. 30, 2021

(54) IDENTIFICATION OF TREND GAPS

(71) Applicant: International Business Machines Corporation, Armonk, NY (US)

(72) Inventors: Vikas C. Raykar, Bangalore (IN); Vijay Ekambaram, Chennai (IN); Akshay Gugnani, New Delhi (IN); Amith Singhee, Bangalore (IN); Surya Shravan Kumar Sajja, Bangalore (IN)

(21) Appl. No.: 16/830,934

(22) Filed: Mar. 26, 2020

(51) Int. Cl. G06Q 30/06; G06Q 30/02; G06K 9/62

(52) U.S. Cl. CPC G06Q 30/0643; G06Q 30/0201; G06K 9/6218; G06K 9/623; G06K 9/6215; G06Q 30/0202

(57) ABSTRACT

One embodiment provides a method, including: receiving a client fashion catalog comprising a plurality of images of client wearable products; creating a market fashion catalog comprising a plurality of market wearable products identified from sources other than the client fashion catalog, wherein the creating comprises (i) accessing a plurality of secondary sources, (ii) capturing information corresponding to market wearable products from the plurality of secondary sources, and (iii) aggregating the information to create the market fashion catalog; generating, for each market wearable product, (iv) a desirability score and (v) a multi-modal description of characteristics; producing, for the market wearable products, by utilizing the multi-modal descriptions, a similarity score indicating how similar the market wearable product is to products within the client fashion catalog, wherein the producing comprises comparing market wearable products to client wearable products; and providing a recommendation for a change to the client fashion catalog.

### BACKGROUND

When creating a fashion catalog, designer(s) provide images and/or descriptions of the wearable objects or products (e.g., articles of clothing, hats, jewelry, scarves, accessories, etc.) that will be included in the catalog. Since fashion catalogs are often utilized for a period of time (e.g., a month, a quarter, a year, etc.), it is most beneficial to the seller that the wearable objects will be on trend for most of that period of time. Even with the use of physical fashion catalogs, for example, those that are printed on paper, being replaced in favor of digital fashion catalogs, the publisher wants the objects within the catalog to be on trend. Even though the digital catalog is easier to modify and, therefore, easier to publish more frequently, it still takes time and resources to create and publish the catalog. Additionally, many consumers do not want to receive a new catalog every day, even in digital form. Therefore, the objects included in the catalog should be directed towards those objects that are being bought by the most consumers.

### BRIEF SUMMARY

In summary, one aspect of the invention provides a method, comprising: receiving a client fashion catalog comprising a plurality of images of client wearable products; creating a market fashion catalog comprising a plurality of market wearable products identified from sources other than the client fashion catalog, wherein the creating comprises (i) accessing a plurality of secondary sources, (ii) capturing information corresponding to market wearable products from the plurality of secondary sources, and (iii) aggregating the information to create the market fashion catalog; generating, for each market wearable product, (iv) a desirability score and (v) a multi-modal description of characteristics of the market wearable product; producing, for the market wearable products, by utilizing the multi-modal descriptions, a similarity score indicating how similar the market wearable product is to products within the client fashion catalog, wherein the producing comprises comparing market wearable products to client wearable products; and providing, based upon (vi) the desirability scores and (vii) the similarity scores of the market wearable products, a recommendation for a change to the client fashion catalog.

Another aspect of the invention provides an apparatus, comprising: at least one processor; and a computer readable storage medium having computer readable program code embodied therewith and executable by the at least one processor, the computer readable program code comprising: computer readable program code configured to receive a client fashion catalog comprising a plurality of images of client wearable products; computer readable program code configured to create a market fashion catalog comprising a plurality of market wearable products identified from sources other than the client fashion catalog, wherein the creating comprises (i) accessing a plurality of secondary sources, (ii) capturing information corresponding to market wearable products from the plurality of secondary sources, and (iii) aggregating the information to create the market fashion catalog; computer readable program code configured to generate, for each market wearable product, (iv) a desirability score and (v) a multi-modal description of characteristics of the market wearable product; computer readable program code configured to produce, for the market wearable products, by utilizing the multi-modal descriptions, a similarity score indicating how similar the market wearable product is to products within the client fashion catalog, wherein the producing comprises comparing market wearable products to client wearable products; and computer readable program code configured to provide, based upon (vi) the desirability scores and (vii) the similarity scores of the market wearable products, a recommendation for a change to the client fashion catalog.

An additional aspect of the invention provides a computer program product, comprising: a computer readable storage medium having computer readable program code embodied therewith, the computer readable program code executable by a processor and comprising: computer readable program code configured to receive a client fashion catalog comprising a plurality of images of client wearable products; computer readable program code configured to create a market fashion catalog comprising a plurality of market wearable products identified from sources other than the client fashion catalog, wherein the creating comprises (i) accessing a plurality of secondary sources, (ii) capturing information corresponding to market wearable products from the plurality of secondary sources, and (iii) aggregating the information to create the market fashion catalog; computer readable program code configured to generate, for each market wearable product, (iv) a desirability score and (v) a multi-modal description of characteristics of the market wearable product; computer readable program code configured to produce, for the market wearable products, by utilizing the multi-modal descriptions, a similarity score indicating how similar the market wearable product is to products within the client fashion catalog, wherein the producing comprises comparing market wearable products to client wearable products; and computer readable program code configured to provide, based upon (vi) the desirability scores and (vii) the similarity scores of the market wearable products, a recommendation for a change to the client fashion catalog.

A further aspect of the invention provides a method, comprising: creating a market catalog comprising a plurality of market wearable products being included within secondary sources, wherein the creating comprises (i) capturing information related to the market wearable products and (ii) associating the captured information with the market wearable product within the market catalog; identifying, for each of the market wearable products, a demand for the market wearable product, wherein the identifying comprises deriving, utilizing the captured information, a demand score for the market wearable product; clustering, utilizing the captured information, market wearable products into clusters comprising products having a similarity within a predetermined threshold; generating, for each cluster, a similarity score identifying a similarity of the cluster to each of a plurality of wearable products included within a client catalog; identifying clusters having a similarity score that indicate a low similarity to the wearable products within the client catalog; and recommending, to a client having the client catalog, that attributes of wearable products be added to the client catalog in view of attributes included in wearable products that are included within the clusters having a low similarity

For a better understanding of exemplary embodiments of the invention, together with other and further features and advantages thereof, reference is made to the following description, taken in conjunction with the accompanying drawings, and the scope of the claimed embodiments of the invention will be pointed out in the appended claims.

### BRIEF DESCRIPTION OF THE SEVERAL VIEWS OF THE DRAWINGS

FIG. 1 illustrates a method of recommending wearable objects to be included in a client fashion catalog based upon identifying trend gaps within the client fashion catalog in view of a market fashion catalog.

FIG. 2 illustrates an example of generating clusters from wearable objects within the market fashion catalog.

FIG. 3 illustrates an example of estimating the trend age.

FIG. 4 illustrates a computer system.

### DETAILED DESCRIPTION

It will be readily understood that the components of the embodiments of the invention, as generally described and illustrated in the figures herein, may be arranged and designed in a wide variety of different configurations in addition to the described exemplary embodiments. Thus, the following more detailed description of the embodiments of the invention, as represented in the figures, is not intended to limit the scope of the embodiments of the invention, as claimed, but is merely representative of exemplary embodiments of the invention.

Reference throughout this specification to “one embodiment” or “an embodiment” (or the like) means that a particular feature, structure, or characteristic described in connection with the embodiment is included in at least one embodiment of the invention. Thus, appearances of the phrases “in one embodiment” or “in an embodiment” or the like in various places throughout this specification are not necessarily all referring to the same embodiment.

Furthermore, the described features, structures, or characteristics may be combined in any suitable manner in at least one embodiment. In the following description, numerous specific details are provided to give a thorough understanding of embodiments of the invention. One skilled in the relevant art may well recognize, however, that embodiments of the invention can be practiced without at least one of the specific details thereof, or can be practiced with other methods, components, materials, et cetera. In other instances, well-known structures, materials, or operations are not shown or described in detail to avoid obscuring aspects of the invention.

The illustrated embodiments of the invention will be best understood by reference to the figures. The following description is intended only by way of example and simply illustrates certain selected exemplary embodiments of the invention as claimed herein. It should be noted that the flowchart and block diagrams in the figures illustrate the architecture, functionality, and operation of possible implementations of systems, apparatuses, methods and computer program products according to various embodiments of the invention. In this regard, each block in the flowchart or block diagrams may represent a module, segment, or portion of code, which comprises at least one executable instruction for implementing the specified logical function(s).

It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

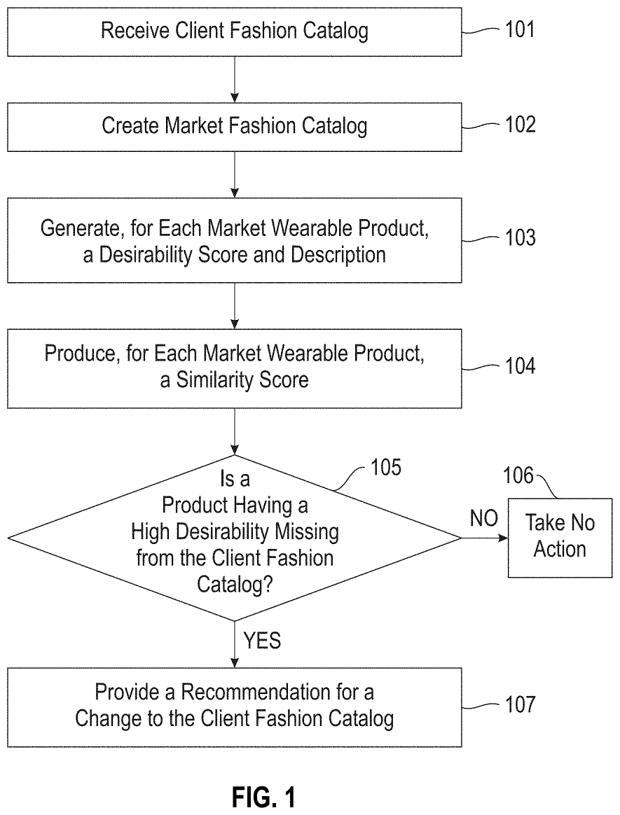

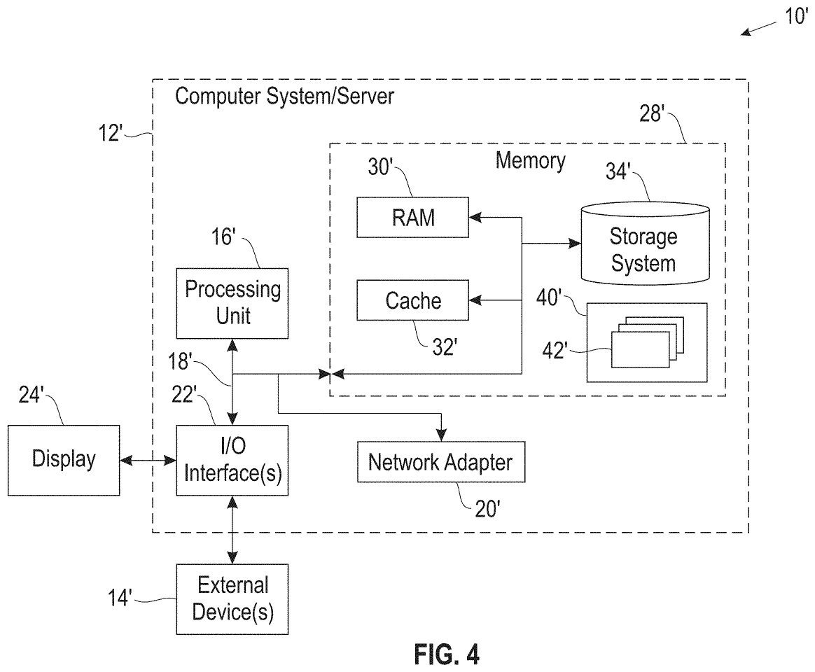

Specific reference will be made here below to FIGS. 1-4. It should be appreciated that the processes, arrangements and products broadly illustrated therein can be carried out on, or in accordance with, essentially any suitable computer system or set of computer systems, which may, by way of an illustrative and non-restrictive example, include a system or server such as that indicated at 12′ in FIG. 4. In accordance with an example embodiment, most if not all of the process steps, components and outputs discussed with respect to FIGS. 1-3 can be performed or utilized by way of a processing unit or units and system memory such as those indicated, respectively, at 16′ and 28′ in FIG. 4, whether on a server computer, a client computer, a node computer in a distributed network, or any combination thereof.

In generating a fashion catalog, it may be difficult to know or include every wearable object that is on-trend, or that is sought after by consumers. While the creation of a fashion catalog is generally done using fashion designers, market researchers, and product managers, these people may not have a well-rounded view of the trendy fashion. For example, fashion trends may differ across geographies, which may make it difficult for someone in one geography to be aware of the fashion trends that are selling well within a different geography. As another example, some fashion designers, market researchers, and/or product managers may specialize in a particular fashion subset (e.g., clothing, accessories, jewelry, etc.) and may, therefore, not be versed in the trends of a different fashion subset. Thus, a fashion catalog publisher may find that the catalog is missing wearable objects that would sell well.

The fashion catalog publisher may also find that the catalog includes wearable objects that, while currently on-trend, may not be trendy for the shelf life of the catalog. In other words, the wearable objects included in the fashion catalog may not sell well for the period of the catalog or until the next edition of the catalog is published. Additionally, using designers, market researchers, and/or product manager is a time consuming process that can take weeks or months and, at that point, the information may no longer be current. Thus, this is not a cost effective technique to understand market demand and can often lead to incomplete or inaccurate studies which result in catalogs having incomplete or inaccurate wearable objects with respect to current fashion trends.

Accordingly, an embodiment provides a system and method for recommending wearable objects to be included in a client fashion catalog based upon identifying trend gaps within the client fashion catalog in view of a market fashion catalog. The described system and method additionally is able to identify a trend age that indicates how long a trend is likely to be trendy and whether it will last for the age of the fashion catalog. The system receives a client fashion catalog that includes a plurality of images of client wearable products to be included in the catalog. The system creates a market fashion catalog that includes market wearable products. Market wearable products may include wearable products that are captured from secondary sources, for example, Internet websites, social media postings, competitor catalogs, and/or the like. From the secondary sources, the system captures information which may include images and/or text corresponding to the wearable product. The system then combines the information from each of the plurality of wearable products into the market fashion catalog. The market fashion catalog then provides an indication of those wearable products that are being sold, worn, and otherwise consumed by consumers.

For each wearable product in the market catalog, the system generates a desirability or demand score which provides an indication of the market desire or demand for a particular wearable product. The system also, for each wearable product, creates a description of characteristics or features of the product. The description may be a multi-modal description, for example, including images, text, or the like. The characteristics may be those characteristics that make up the product, for example, color, design, material, size of different features, a description of the features, and the like. The system can then compare the market wearable products with the client wearable products to produce a similarity score that indicates the similarity of the market wearable product with the client wearable products. Using the similarity scores the system can identify those market wearable products or features thereof that are not included in the client catalog. For those market wearable products that have been identified as not being included in the client fashion catalog, the system determines if those products have a high desirability or demand score. If the products do have a high demand score, the system provides a recommendation to the client to include wearable products that are similar to or that have the characteristics of the market wearable product.

Such a system provides a technical improvement over current systems for generating fashion catalogs. Rather than relying on fashion designers, product managers, market researchers, or the like, the system provides an automated system for determining the trends of the market. These trends can then be used to provide recommendations for products to be included in a client fashion catalog. Thus, instead of the time extensive and cost inefficient conventional techniques that result in incomplete or inaccurate market studies, the described technique is more time and cost efficient and results in more complete and accurate market studies. Additionally, since the described techniques are more cost and time efficient, the results provide more current and up-to-date information, thereby allowing retailers and catalog producers to provide catalogs having wearable products that are more likely to appeal to consumers and for a longer period of time.

FIG. 1 illustrates a method for recommending wearable objects to be included in a client fashion catalog based upon identifying trend gaps within the client fashion catalog in view of a market fashion catalog. At 101 the system receives a client fashion catalog that includes a plurality of images of client wearable products. The client catalog may also include text descriptions of some or all of the wearable products. Additionally, depending on the medium of the client catalog (e.g., digital, printed, etc.), the client catalog may also include information in other modalities, for example, videos, audio, and the like. While a catalog may traditionally be thought of as being a large catalog that has many pages, either digital or printed, a catalog may also be a smaller form, for example, as a product mailer, website advertisement, or the like. In other words, the catalog does not need to be a full catalog or online product listing, rather, the catalog may only include a handful of wearable products.

Receiving the client fashion catalog may include a user or client uploading the products to the system, either directly, for example, through a PDF document, scanning the information into the system, uploading all of the products to the system, or the like, or through provision of a link or pointer, for example, a uniform resource locator pointer, link to a data storage location, or the like. Receipt of the client fashion catalog may also include the system accessing a data storage location or other location where the client fashion catalog is stored, for example, a local, remote, network, cloud, or the like storage location, an Internet website, or the like.

At 102 the system creates a market fashion catalog. The market fashion catalog provides information regarding the wearable products (e.g., articles of clothing, accessories, jewelry, hats, shoes, etc.) that people are currently wearing or that are currently being marketed, for example, by competitors, fashion designers, or the like. Thus, the market fashion catalog may be created from information captured from consumers, competitors, fashion designers, fashion shows, or the like. To create the market fashion catalog the system accesses secondary sources that have wearable products, where the secondary sources include sources other than the client fashion catalog. Secondary sources can include any source that displays, provides, or otherwise includes wearable products. For example, the secondary sources may include Internet websites or pointers to Internet websites (e.g., competitor websites, seller websites, retailer websites, comment sections, review sections, etc.), social media (e.g., networking sites, blogs, etc.), trend documents (e.g., historical market pattern documents, product data, printed documents, etc.), and the like.

The system then captures, from the secondary sources, information corresponding to market wearable products. To capture the information the system may employ one or more parsers. The system may include a parser that is able to extract information from any type of information source, or, alternatively, may include unique parsers for each information source. For example, the system may employ a web parser that can take Internet pointers, for example, uniform resource locators (URLs), and scrape information from the Internet site. As another example, the system may employ a document or text parser that can take the trend documents and use an extractive summarization algorithm to capture the information.

The information may include images, text, audio, video, metadata, or the like, corresponding to each market wearable product. For example, the system may access an Internet website, extract an image of a wearable product, and extract any description included with the wearable product. As another example, the system may access a social media site having an image of a person wearing a wearable product and extract comments related to the wearable product. The system attempts to capture any information that may be associated with a wearable product, for example, reviews of a wearable product, comments corresponding to a wearable product, metadata (e.g., timestamps, posting provider, number of views, etc.), descriptions of wearable products, images of a wearable product, and the like. The system may also access multiple sources for a single wearable product. For example, the system may determine that the same wearable product is included in many different sources and may assemble all information related to the wearable product into a single listing within the market fashion catalog. Additionally, the system captures information that may be indicative of the demand corresponding to a market wearable product, for example, comments, sentiment analysis, number of views, number of positive indications, and the like.

Once the system has the wearable products and information corresponding to the wearable products, the system may combine the information into the market fashion catalog. For each market wearable product the system may generate a desirability score and a description at 103. The description may be multi-modal and may, therefore, include both a visual embedding representation of the image and textual embedding representation of the product description. To generate the visual embedding representation the system may use an image classification algorithm, neural network, or the like. To generate the textual embedding representation the system may leverage sentence encoding techniques, natural language sentence generators, or the like. The system may then combine both the visual and textual embeddings into a multi-modal embedding using joint representation techniques, concatenation techniques, or the like.

The market catalog also includes information related to the demand or desirability of the product. Using this information the system can generate both a current or temporal demand signal and also a forecasted demand signal. The current demand signal provides an indication of the current desirability or demand of the product within the market. The forecasted demand signal is generated for a particular time period, for example, the life of the client catalog, a particular season, a particular number of days or weeks, or any other time period which may be provided by a user or a default value. Both of these signals may be determined based upon user sentiment, number of positive indications, text analysis of comments or reviews, or the like. The forecasted demand signal may be generated by using a neural network, time series forecasting, or the like, to forecast the demand signals for the particular time period using the temporal demand signals as a basis.

Once the market catalog is generated the system may produce a similarity score for each market wearable product. The similarity score indicates a similarity of the market wearable product to products within the client fashion catalog. To determine the similarity, the system may use any of a plurality of similarity measurement techniques (e.g., cosine similarity, clustering techniques, class distribution measures, affinity measurements, similarity measures, etc.) or a combination thereof. In determining the similarity the system may compare aspects or characteristics (e.g., textures, materials, color, feature size, feature shape, size, etc.) of the market wearable product to aspects or characteristics of the client wearable product. The system may compare each market wearable product to each client wearable product and, thereafter, determine an aggregate similarity score for the market wearable product. Similarly, the system may produce an overall similarity score for the client fashion catalog which identifies a similarity of the client fashion catalog to the market fashion catalog.

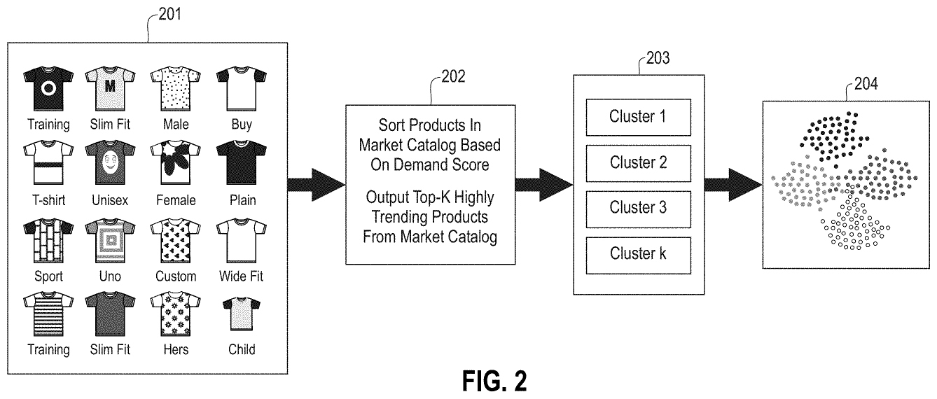

In order to reduce the amount of necessary processing, the system may cluster the wearable products within the market fashion catalog into clusters having similar products. Determining a similarity may be performed utilizing similarity algorithms, cosine similarity, and the like, which may be performed on the textual embeddings, the visual embeddings, multi-modal description, images, or a combination thereof. The determination of similarity may be based upon the products within the cluster having a similarity within a predetermined similarity threshold. Instead of comparing each individual market product to the client products, the system may instead compare a cluster to each client product. The similarity score may then be generated for each cluster. FIG. 2 illustrates and example of generating the market fashion catalog, and, specifically, creating clusters from the information included in the market fashion catalog. 201 includes all the wearable products that were extracted or identified from the secondary sources. From all the wearable products that were extracted, the system clusters the similar products at 203.

In an optional step, the system may sort and rank the products within the market catalog based upon the demand scores corresponding to the market products. Those market products having a higher demand score will be ranked higher. The system may then output a predetermined number, for example, the top-k number, of market products at 202. These products would correspond to those market products having the highest demand or desirability as determined using the demand scores. The advantage of performing this optional step is that only those products having the highest demand would be used for determining the market trend gaps. Another advantage is that by reducing the number of products, the system requires less time and processing resources to perform the analysis. The number of highest ranked products will then be clustered based upon similarity at 203. The output would then be similar looking market catalog products are clustered together at 204. Although shown in FIG. 2, the system may not actually output a graph as shown at 204. Rather, this is used as an illustration.

Using the similarity score the system can identify the attributes or characteristics of the market wearable products that cause the product to be on trend or desirable. Whether the similarity scores with respect to the client fashion catalogs are based upon market catalog clusters or each individual market product, the system may rank the clusters or market wearable products based upon the similarity scores. The clusters or products having the least similarity to the client wearable products may be ranked the highest. In other words, the clusters or products may be ranked in descending order utilizing the similarity scores. This results in the market products or features that are not included in the client catalog being ranked the highest. If the products were also ranked based upon the demand or desirability scores, then the products or clusters located at the top of the list are not only the products that are not included in the client catalog, but are also those products that have the highest demand. In other words, these market products have attributes that should be included in the client catalog but that are not actually included.

Accordingly, the system determines, at 105, if a product having a high desirability is missing from the client fashion catalog based upon the rankings. This determination is made based upon the desirability scores and similarity scores of the market wearable products. Products having a high desirability score and a low similarity score indicate products that are missing from the client catalog but that have a high desirability. If products having a high desirability are not missing from the client catalog, then the system may take no action at 106. If, on the other hand, a product having a high desirability is missing from the catalog, the system may provide a recommendation for a change to the client fashion catalog at 107. For example, the system may recommend that a product having a higher similarity to the market product be added to the client catalog. As another example, the system may recommend that a product already included in the client catalog be modified or changed to include the attributes or characteristics that make the market product highly desirable.

The system can also make recommendations based upon a trend age score. For example, the system may recommend the addition or deletion of a product based upon the trend age score of the product. The trend age score identifies a time period for when the market wearable product is desirable. To get the most out of the catalog, a catalog producer may prefer to include products that will have a high desirability for the time period of the catalog, rather than products where the desirability is waning. Thus, if the trend age score identifies that the trend for a product or attribute is almost over, the system may recommend that the product be replaced with something having a longer trend age score. To identify the trend age score, the system utilizes the forecasted demand score. The system then aggregates the forecasted demand scores for all the market products that are similar to the client products. By analyzing the temporal nature of the forecasted demand score, since it is based upon a time period, the system can determine how the forecasted demand score has historically changed and use this information to determine the time-range for when the demand signals were high. The system can then compute a trend age score by comparing the time-range to the current time. Using this same technique, the system can compute a trend age score for the entire client catalog by aggregating the trend age of all products included in the catalog.

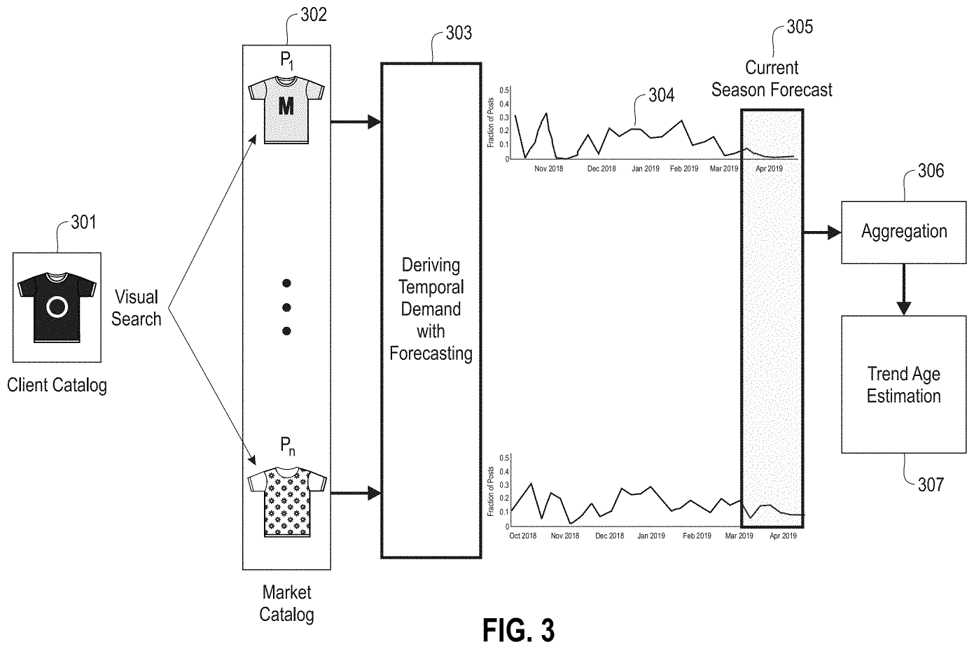

FIG. 3 illustrates an example of computing the trend age score. The products of the client catalog 301 are compared to products of the market catalog 302 to determine a similarity between the products of the client catalog and the products of the market catalog, which may include determining a similarity of the overall products or attributes of the products. At 303 the system can derive the temporal demand with the forecasting to generate a historical demand signal graph for a time-range 304. The system then compares the time-range to the current season or time period to result in the current season forecast 305. Aggregating the trend age score for all products within the client catalog 306 results in a trend age estimation for the client catalog 307.

As shown in FIG. 4, computer system/server 12′ in computing node 10′ is shown in the form of a general-purpose computing device. The components of computer system/server 12′ may include, but are not limited to, at least one processor or processing unit 16′, a system memory 28′, and a bus 18′ that couples various system components including system memory 28′ to processor 16′. Bus 18′ represents at least one of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 12′ typically includes a variety of computer system readable media. Such media may be any available media that are accessible by computer system/server 12′, and include both volatile and non-volatile media, removable and non-removable media.

System memory 28′ can include computer system readable media in the form of volatile memory, such as random access memory (RAM) 30′ and/or cache memory 32′. Computer system/server 12′ may further include other removable/non-removable, volatile/non-volatile computer system storage media. By way of example only, storage system 34′ can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18′ by at least one data media interface. As will be further depicted and described below, memory 28′ may include at least one program product having a set (e.g., at least one) of program modules that are configured to carry out the functions of embodiments of the invention.

Program/utility 40′, having a set (at least one) of program modules 42′, may be stored in memory 28′ (by way of example, and not limitation), as well as an operating system, at least one application program, other program modules, and program data. Each of the operating systems, at least one application program, other program modules, and program data or some combination thereof, may include an implementation of a networking environment. Program modules 42′ generally carry out the functions and/or methodologies of embodiments of the invention as described herein.

Computer system/server 12′ may also communicate with at least one external device 14′ such as a keyboard, a pointing device, a display 24′, etc.; at least one device that enables a user to interact with computer system/server 12′; and/or any devices (e.g., network card, modem, etc.) that enable computer system/server 12′ to communicate with at least one other computing device. Such communication can occur via I/O interfaces 22′. Still yet, computer system/server 12′ can communicate with at least one network such as a local area network (LAN), a general wide area network (WAN), and/or a public network (e.g., the Internet) via network adapter 20′. As depicted, network adapter 20′ communicates with the other components of computer system/server 12′ via bus 18′. It should be understood that although not shown, other hardware and/or software components could be used in conjunction with computer system/server 12′. Examples include, but are not limited to: microcode, device drivers, redundant processing units, external disk drive arrays, RAID systems, tape drives, and data archival storage systems, etc.

This disclosure has been presented for purposes of illustration and description but is not intended to be exhaustive or limiting. Many modifications and variations will be apparent to those of ordinary skill in the art. The embodiments were chosen and described in order to explain principles and practical application, and to enable others of ordinary skill in the art to understand the disclosure.

Although illustrative embodiments of the invention have been described herein with reference to the accompanying drawings, it is to be understood that the embodiments of the invention are not limited to those precise embodiments, and that various other changes and modifications may be affected therein by one skilled in the art without departing from the scope or spirit of the disclosure.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions. These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A method, comprising:
receiving a client fashion catalog comprising a plurality of images of client wearable products;
creating a market fashion catalog comprising a plurality of market wearable products identified from sources other than the client fashion catalog, wherein the creating comprises (i) accessing a plurality of secondary sources, (ii) capturing information corresponding to market wearable products from the plurality of secondary sources, and (iii) aggregating the information to create the market fashion catalog;
generating, for each market wearable product, (iv) a desirability score and (v) a multi-modal description of characteristics of the market wearable product;
producing, for the market wearable products, by utilizing the multi-modal descriptions, a similarity score indicating how similar the market wearable product is to products within the client fashion catalog, wherein the producing comprises comparing market wearable products to client wearable products; and
providing, based upon (vi) the desirability scores and (vii) the similarity scores of the market wearable products, a recommendation for a change to the client fashion catalog.

2. The method of claim 1, comprising clustering market wearable products into clusters of similar products, wherein the clustering comprises utilizing a similarity clustering technique on the multi-modal descriptions to identify similar market wearable products; and
wherein the producing comprises producing a similarity score for each cluster.

3. The method of claim 1, wherein the desirability score comprises two sub-scores corresponding to (i) a current desirability for a corresponding market wearable product and (ii) a forecasted desirability for the corresponding market wearable product, wherein the forecasted desirability is determined over a defined period of time.

4. The method of claim 1, comprising ranking the market wearable products utilizing the similarity scores, wherein those market wearable products being least similar to the client wearable products are ranked highest.

5. The method of claim 1, comprising ranking the market wearable products utilizing the desirability scores, wherein market wearable products having the highest desirability are ranked highest.

6. The method of claim 1, comprising computing a trend age score for the desirability of a market wearable product, wherein the trend age score corresponds to a time period for when the market wearable product is likely to be desirable.

7. The method of claim 6, wherein the recommendation is based upon the trend age score.

8. The method of claim 6, comprising computing a catalog trend age score for the client fashion catalog based upon an aggregation of the trend age scores for the client wearable products, wherein the catalog trend age score corresponds to a time period for when an aggregation of the client wearable products within the client catalog are likely to be desirable.

9. The method of claim 1, comprising identifying characteristics of the market wearable product contributing to the desirability score.

10. The method of claim 1, wherein the multi-modal description comprises both text and images.

11. An apparatus, comprising:
at least one processor; and
a computer readable storage medium having computer readable program code embodied therewith and executable by the at least one processor, the computer readable program code comprising:
computer readable program code configured to receive a client fashion catalog comprising a plurality of images of client wearable products;
computer readable program code configured to create a market fashion catalog comprising a plurality of market wearable products identified from sources other than the client fashion catalog, wherein the creating comprises (i) accessing a plurality of secondary sources, (ii) capturing information corresponding to market wearable products from the plurality of secondary sources, and (iii) aggregating the information to create the market fashion catalog;
computer readable program code configured to generate, for each market wearable product, (iv) a desirability score and (v) a multi-modal description of characteristics of the market wearable product;
computer readable program code configured to produce, for the market wearable products, by utilizing the multi-modal descriptions, a similarity score indicating how similar the market wearable product is to products within the client fashion catalog, wherein the producing comprises comparing market wearable products to client wearable products; and
computer readable program code configured to provide, based upon (vi) the desirability scores and (vii) the similarity scores of the market wearable products, a recommendation for a change to the client fashion catalog.

12. A computer program product, comprising:
a computer readable storage medium having computer readable program code embodied therewith, the computer readable program code executable by a processor and comprising:
computer readable program code configured to receive a client fashion catalog comprising a plurality of images of client wearable products;
computer readable program code configured to create a market fashion catalog comprising a plurality of market wearable products identified from sources other than the client fashion catalog, wherein the creating comprises (i) accessing a plurality of secondary sources, (ii) capturing information corresponding to market wearable products from the plurality of secondary sources, and (iii) aggregating the information to create the market fashion catalog;
computer readable program code configured to generate, for each market wearable product, (iv) a desirability score and (v) a multi-modal description of characteristics of the market wearable product;
computer readable program code configured to produce, for the market wearable products, by utilizing the multi-modal descriptions, a similarity score indicating how similar the market wearable product is to products within the client fashion catalog, wherein the producing comprises comparing market wearable products to client wearable products; and
computer readable program code configured to provide, based upon (vi) the desirability scores and (vii) the similarity scores of the market wearable products, a recommendation for a change to the client fashion catalog.

13. The computer program product of claim 12, comprising clustering market wearable products into clusters of similar products, wherein the clustering comprises utilizing a similarity clustering technique on the multi-modal descriptions to identify similar market wearable products; and
wherein the producing comprises producing a similarity score for each cluster.

14. The computer program product of claim 12, wherein the desirability score comprises two sub-scores corresponding to (i) a current desirability for a corresponding market wearable product and (ii) a forecasted desirability for the corresponding market wearable product, wherein the forecasted desirability is determined over a defined period of time.

15. The computer program product of claim 12, comprising ranking the market wearable products utilizing the similarity scores, wherein those market wearable products being least similar to the client wearable products are ranked highest.

16. The computer program product of claim 12, comprising ranking the market wearable products utilizing the desirability scores, wherein market wearable products having the highest desirability are ranked highest.

17. The computer program product of claim 12, comprising computing a trend age score for the desirability of a market wearable product, wherein the trend age score corresponds to a time period for when the market wearable product is likely to be desirable; and
wherein the recommendation is based upon the trend age score.

18. The computer program product of claim 17, comprising computing a catalog trend age score for the client fashion catalog based upon an aggregation of the trend age scores for the client wearable products, wherein the catalog trend age score corresponds to a time period for when an aggregation of the client wearable products within the client catalog are likely to be desirable.

19. The computer program product of claim 12, comprising identifying characteristics of the market wearable product contributing to the desirability score.

20. A method, comprising:
creating a market catalog comprising a plurality of market wearable products being included within secondary sources, wherein the creating comprises (i) capturing information related to the market wearable products and (ii) associating the captured information with the market wearable product within the market catalog;
identifying, for each of the market wearable products, a demand for the market wearable product, wherein the identifying comprises deriving, utilizing the captured information, a demand score for the market wearable product;
clustering, utilizing the captured information, market wearable products into clusters comprising products having a similarity within a predetermined threshold;
generating, for each cluster, a similarity score identifying a similarity of the cluster to each of a plurality of wearable products included within a client catalog;
identifying clusters having a similarity score that indicate a low similarity to the wearable products within the client catalog; and
recommending, to a client having the client catalog, that attributes of wearable products be added to the client catalog in view of attributes included in wearable products that are included within the clusters having a low similarity.
